(19) United States
(12) Patent Application Publication
(10) Pub. No.: US 2018/0139158 A1
(43) Pub. Date: May 17, 2018

(54) SYSTEM AND METHOD FOR MULTIPURPOSE AND MULTIFORMAT INSTANT MESSAGING

(71) Applicant: John Eagleton, Taos, NM (US)

(72) Inventor: John Eagleton, Taos, NM (US)

(21) Appl. No.: 15/808,656

(22) Filed: Nov. 10, 2017

Related U.S. Application Data
(60) Provisional application No. 62/421,203, filed on Nov. 11, 2016.

(51) Int. Cl. H04L 12/58

(52) U.S. Cl. CPC H04L 51/066; H04L 51/046; H04L 51/20; H04L 51/38; H04L 51/12; H04L 51/10; H04L 51/36; H04L 51/02

(57) ABSTRACT

Methods, systems, and devices for multipurpose and multiformat instant messaging are described. A sender of an instant message can determine the format for sending a message (e.g., in text, audio or video format), and the receiver of the instant message can determine the format for receiving the instant message in either text, audio or video format. Sentiment information, location information, weather information and chatterbot messages may also be displayed to the receiver. Conversion of an instant text message to an audio or video message may include the insertion of a token into the audio or video message, and conversion of an audio or video message to an text instant message includes validating a token extracted from the audio or video message.

### CROSS-REFERENCE TO RELATED APPLICATION(S)

This application claims priority to provisional application No. 62/421,203 to Eagleton, entitled ‘SYSTEM AND METHOD FOR MULTIPURPOSE AND MULTIFORMAT INSTANT MESSAGING’, which is expressly incorporated by reference herein in its entirety.

### BACKGROUND

The following relates generally to instant messaging, and more specifically to multipurpose and multiformat instant messaging such as exchanging messages between instant text messaging users and instant audio or video messaging users.

Users of instant messaging systems can send and receive single-format instant messages. For example, if the sender of an instant message sends the message in text format, then the receiver will receive in text format; if the sender of an instant message sends the message in audio format, then the receiver will receive in audio format; if the sender of an instant message sends the message in video format, then the receiver will receive in video format. However, in some cases, the format most appropriate for the sender may be different from a format desired by the receiver.

### SUMMARY

A sender of an instant message can determine the format for sending a message (e.g., in text, audio or video format), and the receiver of the instant message can determine the format for receiving the instant message (e.g., in text, audio or video format). Sentiment information, location information, weather information and chatterbot messages may also be displayed to the receiver. Conversion of an instant text message to an audio or video message may include the insertion of a token into the audio or video message, and conversion of an audio or video message to a text instant message includes validating a token extracted from the audio or video message.

The present disclosure describes methods to provide users of instant messaging systems with a both a multi-format and multipurpose system and method of controlling the input and output format of the instant messages. Additionally, the present disclosure describes methods to provide users of instant messaging systems with a multi-format system and method of controlling the input and output format of the instant messages in either text, audio, video or other visual formats.

Additionally, the present disclosure describes methods to provide users of instant messaging systems with a multipurpose system and method of sending and receiving messages depending upon user sentiment in either text, audio, video or other visual formats. Additionally, the present disclosure describes methods to provide users of instant messaging systems with a multipurpose system and method of automatically sending messages based on chatterbot settings. Additionally, the present disclosure describes methods to provide users with the capability of recognizing the face of the person or personal avatar in a video file and to be able to automatically send that image or video file to the person.

Additionally, the present disclosure describes methods to create a personalized criteria system which will analyze all information received in any format, and based on user profile and settings, the system would be able to determine based on a multidimensional matrix, the characteristics of the information. For example, audio, light, smell, perception, taste, in combination with the quality, quantity, entropy, emotions, aggregation, confidentiality, actuality and usefulness of the information. Additionally, the present disclosure describes methods to display the output of the information, messages, text, data, using the rapid serial visual presentation (RSVP) method.

In one embodiment, a method may include receiving a message generated in a first format, identifying a second format different from the first format, wherein the first format and the second format each comprise a text format, a text markup format, an audio format, a video format, an RSVP format, or any combination thereof, and displaying the message to a user in the second format based on identifying the second format.

In one embodiment, a non-transitory computer-readable medium may include instructions operable to cause a processor to receive a message generated in a first format, identify a second format different from the first format, wherein the first format and the second format each comprise a text format, a text markup format, an audio format, a video format, an RSVP format, or any combination thereof, and display the message to a user in the second format based on identifying the second format.

In one embodiment, an apparatus may include a processor, memory in electronic communication with the processor, and instructions stored in the memory. The instructions may be operable to cause the processor to receive a message generated in a first format, identify a second format different from the first format, wherein the first format and the second format each comprise a text format, a text markup format, an audio format, a video format, an RSVP format, or any combination thereof, and display the message to a user in the second format based on identifying the second format.

In one embodiment, an apparatus may include means for receiving a message generated in a first format, means for identifying a second format different from the first format, wherein the first format and the second format each comprise a text format, a text markup format, an audio format, a video format, an RSVP format, or any combination thereof, and means for displaying the message to a user in the second format based on identifying the second format.

Some examples of the method, non-transitory computer-readable medium, and apparatus described above may further include processes, features, means, or instructions for identifying sentiment information of the message, wherein the sentiment information comprises a representation of an emotion, an urgency level a sentiment, or any combination thereof a sender of the message. Some examples of the method, non-transitory computer-readable medium, and apparatus described above may further include processes, features, means, or instructions for displaying a sentiment indication with the message based on the sentiment information.

In some examples of the method, non-transitory computer-readable medium, and apparatus described above, the sentiment indication comprises a color, a sound, an image, an icon, a smell, a tactile response, or any combination thereof.

Some examples of the method, non-transitory computer-readable medium, and apparatus described above may further include processes, features, means, or instructions for identifying a location of the sender of the message. Some examples of the method, non-transitory computer-readable medium, and apparatus described above may further include processes, features, means, or instructions for displaying an indication of the location with the message.

Some examples of the method, non-transitory computer-readable medium, and apparatus described above may further include processes, features, means, or instructions for identifying weather information associated with the message. Some examples of the method, non-transitory computer-readable medium, and apparatus described above may further include processes, features, means, or instructions for displaying the weather information with the message. In some examples of the method, non-transitory computer-readable medium, and apparatus described above, the message may be a chatterbot message.

Some examples of the method, non-transitory computer-readable medium, and apparatus described above may further include processes, features, means, or instructions for identifying a usefulness parameter of the message, wherein the message may be displayed based at least in part on the usefulness information.

In some examples of the method, non-transitory computer-readable medium, and apparatus described above, the message comprises a short message service (SMS) message. In one embodiment, a method may include receiving a message from a first user equipment (UE) in a first format, converting the message to the second format different from the first format, wherein the first format and the second format each comprise a text format, an audio format, a video format, an RSVP format, or any combination thereof, and transmitting the message to a second UE in the second format based on the conversion.

In one embodiment, a non-transitory computer-readable medium may include instructions operable to cause a processor to receive a message from a first UE in a first format, convert the message to the second format different from the first format, wherein the first format and the second format each comprise a text format, an audio format, a video format, an RSVP format, or any combination thereof, and transmit the message to a second UE in the second format based on the conversion.

In one embodiment, an apparatus may include a processor, memory in electronic communication with the processor, and instructions stored in the memory. The instructions may be operable to cause the processor to receive a message from a first UE in a first format, convert the message to the second format different from the first format, wherein the first format and the second format each comprise a text format, an audio format, a video format, an RSVP format, or any combination thereof, and transmit the message to a second UE in the second format based on the conversion.

In one embodiment, an apparatus may include means for receiving a message from a first UE in a first format, means for converting the message to the second format different from the first format, wherein the first format and the second format each comprise a text format, an audio format, a video format, an RSVP format, or any combination thereof, and means for transmitting the message to a second UE in the second format based on the conversion.

Some examples of the method, non-transitory computer-readable medium, and apparatus described above may further include processes, features, means, or instructions for generating a chatterbot message based at least in part on an automatic message generation algorithm. Some examples of the method, non-transitory computer-readable medium, and apparatus described above may further include processes, features, means, or instructions for transmitting the chatterbot message to the second UE.

Some examples of the method, non-transitory computer-readable medium, and apparatus described above may further include processes, features, means, or instructions for identifying sentiment information of the message, wherein the sentiment information comprises a representation of an emotion, an urgency level a sentiment, or any combination thereof a sender of the message. Some examples of the method, non-transitory computer-readable medium, and apparatus described above may further include processes, features, means, or instructions for transmitting a sentiment indication with the message based on the sentiment information.

In some examples of the method, non-transitory computer-readable medium, and apparatus described above, the sentiment information comprises a sentiment mode setting of the first UE, the second UE, or both. In some examples of the method, non-transitory computer-readable medium, and apparatus described above, the sentiment information may be based on the content of the message.

Some examples of the method, non-transitory computer-readable medium, and apparatus described above may further include processes, features, means, or instructions for processing the content of the message using a computer learning algorithm, wherein the sentiment information may be based on processing the content of the message.

Some examples of the method, non-transitory computer-readable medium, and apparatus described above may further include processes, features, means, or instructions for identifying a location of the sender of the message. Some examples of the method, non-transitory computer-readable medium, and apparatus described above may further include processes, features, means, or instructions for transmitting the location to the second UE.

Some examples of the method, non-transitory computer-readable medium, and apparatus described above may further include processes, features, means, or instructions for identifying weather information associated with the message. Some examples of the method, non-transitory computer-readable medium, and apparatus described above may further include processes, features, means, or instructions for transmitting the weather information to the second UE.

Some examples of the method, non-transitory computer-readable medium, and apparatus described above may further include processes, features, means, or instructions for identifying a usefulness parameter of the message. Some examples of the method, non-transitory computer-readable medium, and apparatus described above may further include processes, features, means, or instructions for filtering the message based on the usefulness parameter, wherein the message may be transmitted based at least in part on the usefulness information. Some examples of the method, non-transitory computer-readable medium, and apparatus described above may further include processes, features, means, or instructions for identifying a filter setting of the second UE, wherein filtering the message may be based on the filter setting.

### BRIEF DESCRIPTION OF THE DRAWINGS

FIG. 1 shows a diagram of a multiformat messaging system that supports multipurpose and multiformat instant messaging in accordance with aspects of the present disclosure.

FIG. 2 shows a diagram of a user equipment (UE) that supports multipurpose and multiformat instant messaging in accordance with aspects of the present disclosure.

FIG. 3 shows a diagram of a multiformat messaging interface that supports multipurpose and multiformat instant messaging in accordance with aspects of the present disclosure.

FIG. 4 shows a diagram of a format conversion that supports multipurpose and multiformat instant messaging in accordance with aspects of the present disclosure.

FIG. 5 shows a diagram of a rapid serial visual presentation (RSVP) interface that supports multipurpose and multiformat instant messaging in accordance with aspects of the present disclosure.

FIG. 6 shows a diagram of a server that supports multipurpose and multiformat instant messaging in accordance with aspects of the present disclosure.

FIGS. 7 through 12 show flowcharts of a process for multipurpose and multiformat instant messaging in accordance with aspects of the present disclosure.

### DETAILED DESCRIPTION

The present disclosure includes methods and systems for improving instant messaging systems. A sender of an instant message can determine the format for sending a message, and the receiver of the instant message can determine the format for receiving the instant message. For example, an automobile driver as the sender and receiver of instant messages can determine to send and receive instant messages in audio format even if the other person is sending and receiving the instant messages in text format.

In another example, a person who is in a meeting and unable to receive audio formatted communication (i.e. phone calls), can determine to send and receive instant messages in text format even if the other person is sending and receiving in audio format.

In another example, when the user who sends an instant message in text format and includes in the message a smiley-face emoticon such as “hi, how are you? :-)”, the receiver of the instant message who has selected to receive the instant message(s) in video format will see a short video of the sender face with a smile on it and the synthesized audio output: “hi, how are you?”.

In another example, when the user who sends a text message with a sentiment setting of “happy” and the text message is “I am going for a walk”, the receiver of the text message, who has selected to receive the message in video format, will see a video of the smiling face of the sender with the text converted into the synthesized voice of the sender.

In another example, when the user who sends a text message from San Francisco while it is sunny and 80 degrees, with text: “I am going for a walk”, the receiver of the text message, who has selected to receive the message in video format, will see a video of the person saying “I am going for a walk” with the interface showing San Fransisco Sunny 80 degrees with images of the sun and San Fransisco on the video.

In another example, when the user who sends a text message using the sentiment analysis text mining system, the user who is receiving the text message in audio or video format will better understand the sentiment and emotional context of the text message. For example, if a user sends a text message with the following text: “I am inebriated by the exuberance of your verbosity, however the redundancy of your platitudes is too copious for my diminutive powers of comprehension”, then the sentiment text mining system will interpret the sentiment of the sender and convert that sentiment into video format so that the receiver of the message in video format will see a video of the sender with a tired look on their face and the text converted into audio using the text-to-audio converter.

In another example, the sender of an audio message has a sentiment analysis system activated, and the receiver of the audio message, who has selected to receive messages in text format, will better understand the emotional context of the audio message.

In another example, the receiver of an instant message using a chatterbot system, could automatically reply to the sender's message based on a combination of both the sender and receiver's sentiment analysis. For example, the receiver of an instant message has the chatterbot system turned on and his sentiment settings in “happy” mode, and the sender of the instant message asks: “How are you?”, then the receiver's chatterbot would respond: “Happy” in either text, audio or video format.

In another example, the sender of the message has sentiment set to “urgent”, then the receiver of the message would receive the message in “red” color and alarm sound; however if the sender of the message has sentiment set to “not urgent”, then the receiver of the message would receive the message in “blue” color for example, and there would be not urgent alarm sound or no sound.

In another example a user can send a text formatted message with a sentimental purpose and receive an audio or video formatted message converted based on both the format of the receiver and purpose of the sender. In another example a user can send an audio or video formatted message and receive a text formatted message. In another example a user can send an audio formatted message and receive a video formatted message.

One embodiment relates to a method of converting a text formatted instant message into an audio message. The method includes converting the text using computer synthesized and audio voice samples to generate an audio format based on the text message. Another embodiment relates to the text, sentiment and opinion mining of the text message and sentiment analysis tools to determine the sentiment, opinion, mood, and emotions of the user sending the text message so as to be able to convert the expressions of the sentiment and opinion of the text message to an audio or video formatted message reflecting the sentiment and opinion of the sender.

Another embodiment relates to the sender of the instant message who is able to define his/her emotional status to determine the emotional expressions of the text message when converted to audio or video formatted message. Another embodiment related to the sender of an instant message using a combination of a chatterbot and the emotional status defined by the user to respond to messages automatically in text, audio or video format.

Another embodiment related to the sender of an instant text message in one language to be converted into an instant audio or video message in a different language. Another embodiment related to the sender of an instant audio or video message in one language to be converted into an instant text message in a different language. Another embodiment related to the send of an audio or video message in one language to be converted into an audio or video message in a different language.

Another embodiment related to the usefulness of the information which allows the user to filter from all information received, only the useful information. For example, if there is urgent information in audio form, and a person is in a business meeting and does not have the opportunity to listen to the message, then it not useful to that person because the user cannot use that information at that moment in time. However, if the system is able to convert the information from audio to text, then that information may become useful to the user.

Another embodiment related to the display of the information using RSVP methods on small wearable devices. The display of information as a single word or small group of words in a series allows the user to access thousands of words and pages of text more easily on a small interface such as a smartwatch or small screen display which is embedded into any wearable device.

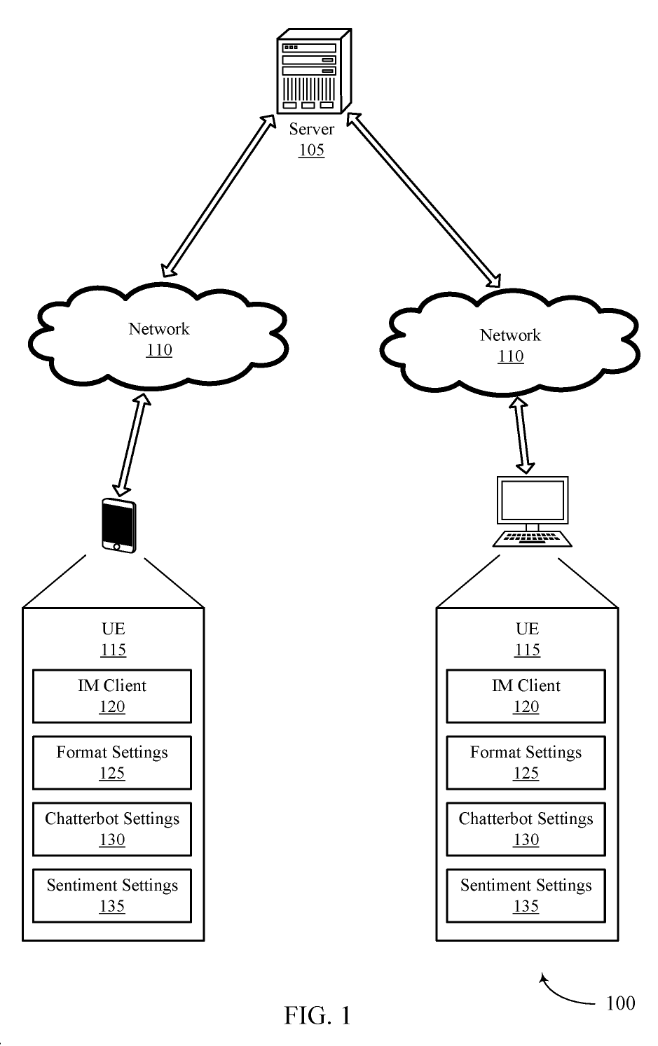

FIG. 1 shows a diagram 100 of a multiformat messaging system that supports multipurpose and multiformat instant messaging in accordance with aspects of the present disclosure. Diagram 100 may include server 105, networks 110, and user equipments (UEs) 115. UEs 115 may communicate multiformat messages by via networks 110 and server 105.

Users of instant messaging systems can send and receive single-format instant messages. For example, if the sender of an instant message sends the message in text format, then the receiver will receive in text format; if the sender of an instant message sends the message in audio format, then the receiver will receive in audio format; if the sender of an instant message sends the message in video format, then the receiver will receive in video format.

According to the present disclosure, a sender of an instant message (i.e., the user of a UE 115) can determine the format for sending the message in either text, audio or video format, and the receiver of the instant message can determine the format for receiving the instant message in either text, audio or video format. For example, the sender of an instant message sends the message in text format and the receiver of the instant message has the option to receive the message in either text, audio or video format. To the instant text messaging user, the experience is a seamless exchange of instant text messages; to the audio or video user, the experience is a seamless exchange of audio or video messages. Conversion of an instant text message to an audio or video message may take place at server 105 and may include the insertion of a token into the audio or video message, and conversion of an audio or video message to a text instant message includes validating a token extracted from the audio or video message.

A multiformat messaging system enables users to exchange messages. To the first user, assuming the user has selected text format from the text-audio-video user settings, which are sent to the server 105, the outgoing messages may be sent in text format, but appear as instant messages in the text, audio or video format specified by the second user in the text-audio-video settings. Conversion between instant messages in text format and audio or video formats is provided by a server 105.

More specifically, a first user may use an IM client to access an instant messaging service to which the user subscribes. As used herein, “subscribes” means that the user is part of the community of users that have identities (e.g., user names, phone numbers, emails, profiles, etc.) recognized by the instant messaging service. In this embodiment, when a user accesses the service, the IM client may establish a connection to an IM server, with the user supplying a pre-established unique user name and a password for authentication.

Alternatively, other methods of authentication might be used, such as smart cards, biometrics, dedicated links, challenge/response, or other. Once the connection is established, the IM client operates an instant messaging program that enables the user to use the service. A user can send a message to anyone in the community of users by selecting the user's name or other identifier. For instance, if another instant messaging user has signed on to the service, the second user can send an instant message to the first user. The instant message and any reply from the first user may be routed through an IM server.

When a user sends an instant message, the instant messaging server may recognizes the user settings (format: text, audio, video; chatterbot, sentiment) of the recipient's message is sending and depending on settings forwards the instant message through the network 110 to the server 105. The server 105 may also determine the chatterbot and/or sentiment purpose of an instant message based on user settings. Based on user text-audio-video settings, server 105 converts the instant message into instant message of another format for the receiving user. The conversion process depends on the preference of the receiver. The server 105 may create a token that is added to the message and any reply to monitor and validate messages within a conversation.

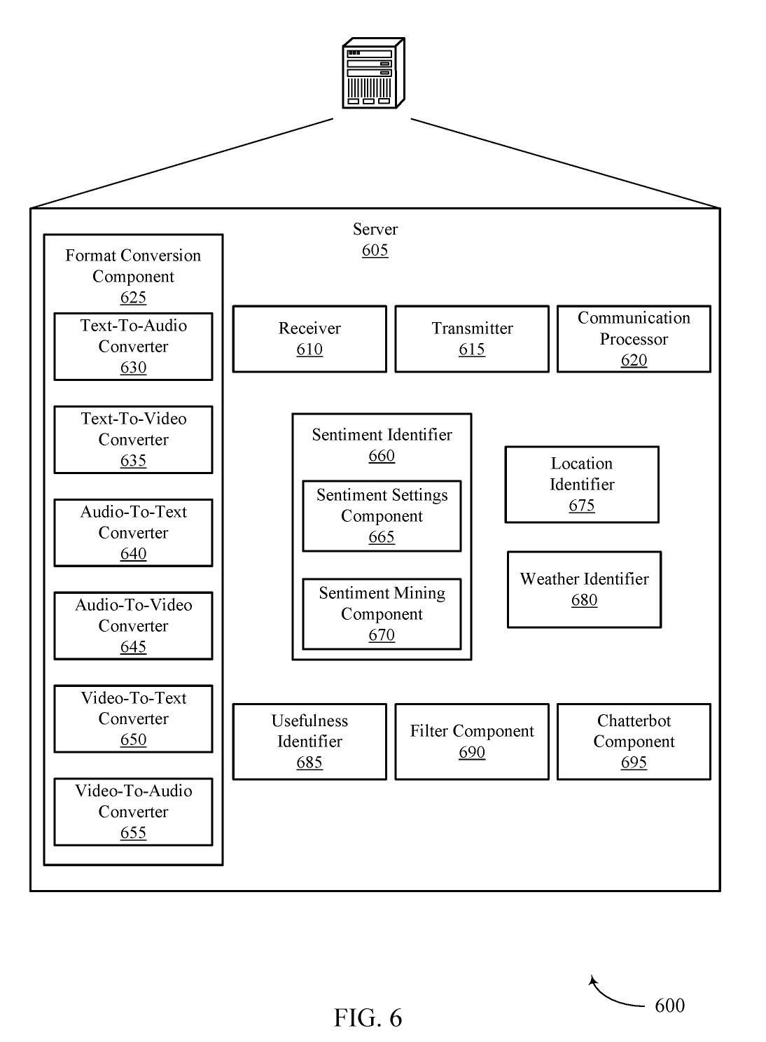

Server 105 may include components for processing information and communicating with other electronic devices. Server 105 incorporate aspects of server 605 as described with reference to FIG. 6.

Networks 110 might be described as the Internet. However, it should be understood that networks 110 can be implemented in a number of ways without departing from the scope of the invention. For example, networks 110 might comprise one or more of a local area network, a wide area network, a wireless network, a store-and-forward system, a legacy network, and a network or transport system subsequently developed. One developing network that might be used is a next-generation Internet.

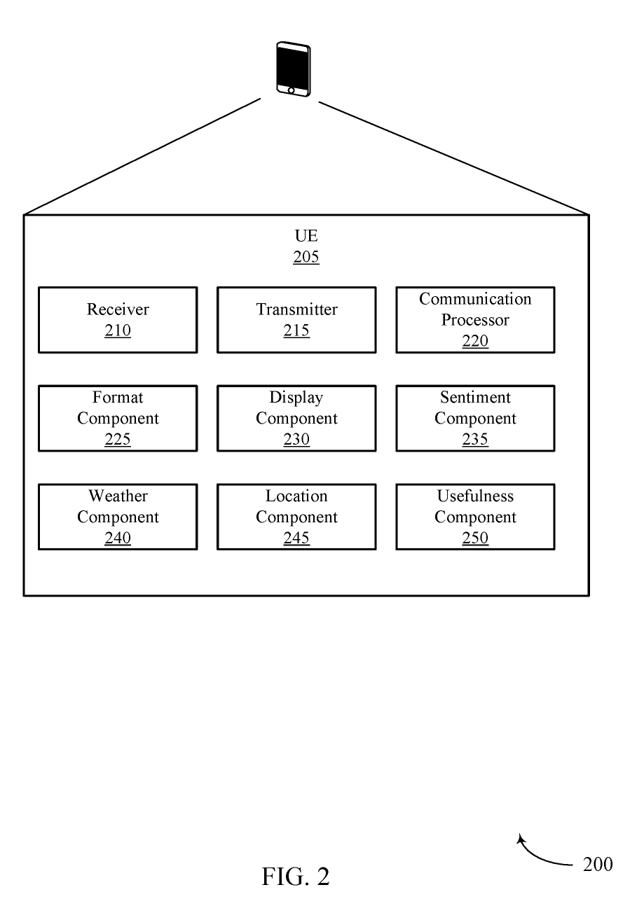

UE 115 may incorporate aspects of UE 205 as described with reference to FIG. 2. In some examples, UE 115 may include IM client 120, format settings 125, chatterbot settings 130, and sentiment settings 135.

FIG. 2 shows a diagram 200 of a UE 205 that supports multipurpose and multiformat instant messaging in accordance with aspects of the present disclosure. UE 205 may incorporate aspects of UE 115 as described with reference to FIG. 1. In some examples, UE 205 may include receiver 210, transmitter 215, communication processor 220, format component 225, display component 230, sentiment component 235, weather component 240, location component 245, and usefulness component 250.

A UE 205 may be wireless communication device such as a cellular phone, PDA, wireless modem, wireless communication device, handheld device, tablet computer, laptop computer, desktop computer, cordless phone, or wireless local loop station. A UE 205 may also be known as a mobile station, subscriber station, mobile unit, subscriber unit, wireless unit, remote unit, mobile device, wireless device, remote device, mobile subscriber station, access terminal, terminal, mobile terminal, wireless terminal, remote terminal, handset, user agent, mobile client, or client. A UE 205 may communicate with a network using various types of base stations and network equipment.

Receiver 210 may receive a message generated in a first format and receive a message from a first UE 205 in a first format. Receiver 210 may incorporate aspects of receiver 610 as described with reference to FIG. 6. Receiver 210 may receive information such as packets, user data, or control information associated with various information channels (e.g., control channels, data channels, and information related to multipurpose and multiformat instant messaging, etc.). Information received at a receiver 210 may be passed on to other components of the device, such as a communication processor 220. In some cases, receiver 210 may be an example of aspects of a transceiver. In various examples, receiver 210 may utilize a single antenna or a plurality of antennas.

Transmitter 215 may transmit the message to a second UE 205 in the second format based on the conversion; transmit the chatterbot message to the second UE 205; transmit a sentiment indication with the message based on the sentiment information; transmit the location to the second UE 205; and transmit the weather information to the second UE 205. Transmitter 215 may incorporate aspects of transmitter 615 as described with reference to FIG. 6. Transmitter 215 may transmit signals generated by other components of a device. Information sent by a transmitter 215 may be received from other components of the device, such as a communication processor 220. In some cases, transmitter 215 may be an example of aspects of a transceiver. In various examples, transmitter 215 may utilize a single antenna or a plurality of antennas.

Communication processor 220 may incorporate aspects of communication processor 620 as described with reference to FIG. 6. Communication processor 220 may process signals such as those received by a receiver, or transmitted by a transmitter 215.

Format component 225 may identify a second format different from the first format, wherein the first format and the second format each comprise a text format, a text markup format, an audio format, a video format, a rapid serial visual presentation (RSVP) format, or any combination thereof. In some cases, the message is a chatterbot message. In some cases, the message comprises a short message service (SMS) message.

Display component 230 may display the message to a user in the second format based on identifying the second format; display a sentiment indication with the message based on the sentiment information; display an indication of the location with the message; and display the weather information with the message.

Sentiment component 235 may identify sentiment information of the message, wherein the sentiment information comprises a representation of an emotion, an urgency level a sentiment, or any combination thereof a sender of the message. In some cases, the sentiment indication comprises a color, a sound, an image, an icon, a smell, a tactile response, or any combination thereof.

Weather component 240 may identify weather information associated with the message. Location component 245 may identify a location of the sender of the message. Usefulness component 250 may identify a usefulness parameter of the message, wherein the message is displayed based at least in part on the usefulness information.

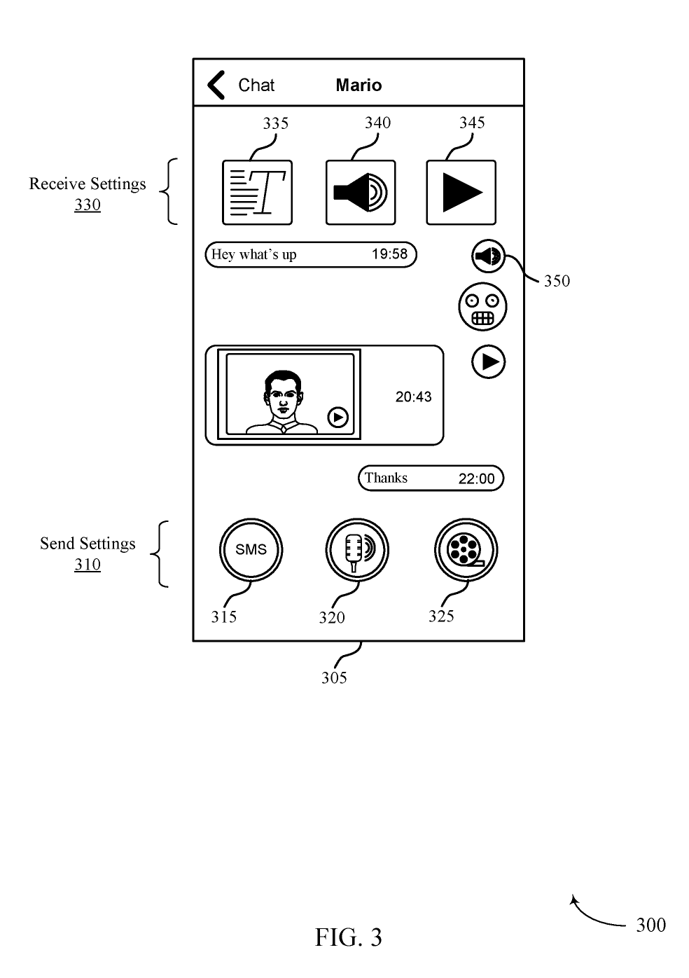

FIG. 3 shows a diagram 300 of a multiformat messaging interface 305 that supports multipurpose and multiformat instant messaging in accordance with aspects of the present disclosure. In some examples, multiformat messaging interface 305 may include send settings 310, receive settings 330, and message format selector 350.

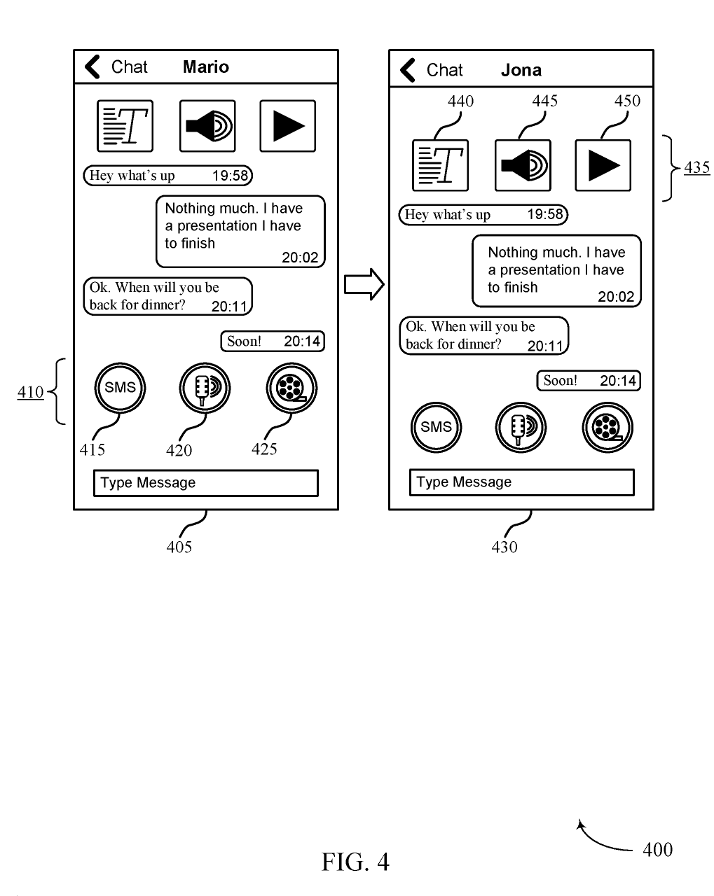

Send settings 310 may incorporate aspects of send settings 410 as described with reference to FIG. 4. In some examples, send settings 310 may include send text setting 315, send audio setting 320, and send video setting 325.

Receive settings 330 may incorporate aspects of receive settings 435 as described with reference to FIG. 4. In some examples, receive settings 330 may include receive text setting 335, receive audio setting 340, and receive video setting 345.

FIG. 4 shows a diagram 400 of a format conversion that supports multipurpose and multiformat instant messaging in accordance with aspects of the present disclosure. Diagram 400 may include sender interface 405 and receiver interface 430.

In some examples, sender interface 405 may include send settings 410. Send settings 410 may incorporate aspects of send settings 310 as described with reference to FIG. 3. In some examples, send settings 410 may include send text setting 415, send audio setting 420, and send video setting 425.

In some examples, receiver interface 430 may include receive settings 435. Receive settings 435 may incorporate aspects of receive settings 330 as described with reference to FIG. 3. In some examples, receive settings 435 may include receive text setting 440, receive audio setting 445, and receive video setting 450.

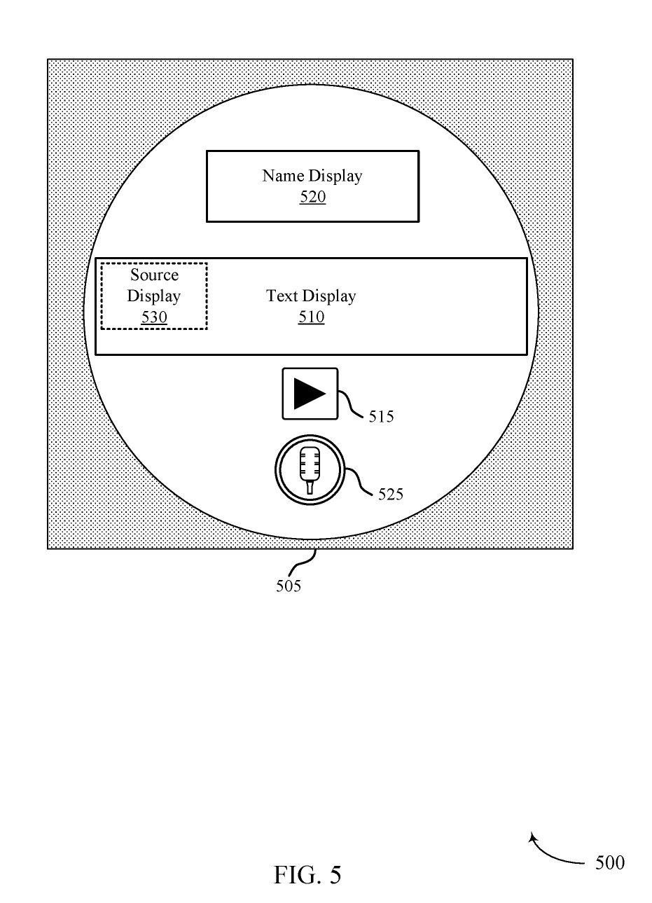

FIG. 5 shows a diagram 500 of a rapid serial visual presentation (RSVP) interface 505 that supports multipurpose and multiformat instant messaging in accordance with aspects of the present disclosure.

In some examples, RSVP interface 505 may include text display 510, play button 515, name display 520, record button 525, and source display 530. RSVP interface 505 may be an example of an interface for displaying multiformat messages using a device such as a watch, a wearable device, an augmented reality device, or any other device suitable for displaying RSVP data.

A multiformat messaging system may convert all information into an RSVP format to allow users to more easily access information on a wearable device such as a smartwatch or glasses connected to a network such as the internet.

Since the information for the RSVP system is organized in a database and categorized, the user can tap on the name display 520 to get the header information, sub-header information, name of person and so on in order to search for the desired information requested. For example, if user is browsing a blog, the name display 520 might display the website headers, the menu categories or other header information and subcategories. Record button 525 allows the user to record an audio message. The audio message is then sent via multiformat messaging system to other users. RSVP interface 505 may also display information about the number of unread messages, and indicate the source of the information (e.g., sender, receiver or other source).

FIG. 6 shows a diagram 600 of a server 605 that supports multipurpose and multiformat instant messaging in accordance with aspects of the present disclosure. Server 605 may incorporate aspects of server 105 as described with reference to FIG. 1. In some examples, server 605 may include receiver 610, transmitter 615, communication processor 620, format conversion component 625, sentiment identifier 660, location identifier 675, weather identifier 680, usefulness identifier 685, filter component 690, and chatterbot component 695.

Receiver 610 may receive a message generated in a first format and receive a message from a first UE in a first format. Receiver 610 may receive information such as packets, user data, or control information associated with various information channels (e.g., control channels, data channels, and information related to multipurpose and multiformat instant messaging, etc.). Information received at a receiver 610 may be passed on to other components of the device, such as a communication processor 620. In some cases, receiver 610 may be an example of aspects of a transceiver. In various examples, receiver 610 may utilize a single antenna or a plurality of antennas.

Transmitter 615 may transmit the message to a second UE in the second format based on the conversion; transmit a chatterbot message to the second UE; transmit a sentiment indication with the message based on the sentiment information; transmit the location to the second UE; and transmit the weather information to the second UE. Transmitter 615 may incorporate aspects of transmitter 215 as described with reference to FIG. 2. Transmitter 615 may transmit signals generated by other components of a device. Information sent by a transmitter 615 may be received from other components of the device, such as a communication processor 620. In some cases, transmitter 615 may be an example of aspects of a transceiver. In various examples, transmitter 615 may utilize a single antenna or a plurality of antennas.

Communication processor 620 may incorporate aspects of communication processor 220 as described with reference to FIG. 2. Communication processor 620 may process signals such as those received by a receiver 610, or transmitted by a transmitter 615.

Format conversion component 625 may convert the message to the second format different from the first format, wherein the first format and the second format each comprise a text format, an audio format, a video format, an RSVP format, or any combination thereof. In some examples, format conversion component 625 may include text-to-audio converter 630, text-to-video converter 635, audio-to-text converter 640, audio-to-video converter 645, video-to-text converter 650, and video-to-audio converter 655.

Sentiment identifier 660 may identify sentiment information of the message, wherein the sentiment information comprises a representation of an emotion, an urgency level a sentiment, or any combination thereof a sender of the message and process the content of the message using a computer learning algorithm, wherein the sentiment information is based on processing the content of the message. In some examples, sentiment identifier 660 may include sentiment settings component 665 and sentiment mining component 670. Sentiment settings component 665 may identify and apply user sentiment settings and sentiment mining component 670 may identify sentiment information based on the content of user generated messages and other information such as weather, location, or time of day.

In some cases, the sentiment information comprises a sentiment mode setting of a first UE, a second UE, or both. In some cases, the sentiment information is based on the content of the message. Sentiment analysis, also known as opinion mining, refers to the use of natural language processing, text analysis and computational linguistics to identify and extract subjective information in source materials. Sentiment analysis may be applied to reviews and social media for a variety of applications, ranging from marketing to customer service.

Location identifier 675 may identify a location of the sender of the message. Weather identifier 680 may identify weather information associated with the message. Usefulness identifier 685 may identify a usefulness parameter of the message.

Filter component 690 may filter the message based on the usefulness parameter, wherein the message is transmitted based at least in part on the usefulness information and identify a filter setting of the second UE, wherein filtering the message is based on the filter setting.

In some cases, information available to users is subjectively divided into useful and not useful information. Useful information means that information, that you are able to use and is useful to the user. For example, if a user has watched a long news podcast, with the aim to have information about the weather in their location, then there is only a small part of the podcast containing information that is useful. That information is classified as useful. The rest of the information on the news podcast is not useful.

Filter component 690 and/or sentiment identifier 660 may utilize a universal personalized criterium operator that may specify the amounts and parts of information that will be useful. In other words, it may decrease the dimension of the available information and convert available information into useful information. Any available information can be represented in a form of tensor (matrix) as illustrated in the table below:

TABLE 1
Multidimensional Matrix

| | A | L | S | P | T |
|---|---|---|---|---|---|
| Time | (audio) | (light) | (smell) | (perception) | (taste) |
| Q (quality) | x | x | x | x | x |
| B (quantity) | x | x | x | x | x |
| C (entropy) | x | x | x | x | x |
| D (emotion) | x | x | x | x | x |
| E (aggregation) | x | x | x | x | x |
| F (confidentiality) | x | x | x | x | x |
| G (actuality) | x | x | x | x | x |
| E (usefulness) | x | x | x | x | x |

The combination of, for example, Quality Q and Audio A; BA; CA; DA; and EA are also multidimensional matrices, specifying more concise parameters (for example, audio quality is specified in audio characteristics in each part of KHz diapason).

Available information (A), useful information (U) and non-useful information (N) and universal personalized criterium operator (F) may be related according to the equation:

FA=F(U+N)=FU+FN=U,

since

FU=U,

FN=0.

We can subtract U from any kind of information, using criteria:

(I−F)X→0,

where X is any information, because

(I−F)U=U−FU=U−U=0,

where I is the identity operator.

Thus, the server 605 may retrieve the maximum amount of useful information. In some cases special conversion is needed. The converter can convert information from one type to other (for example, from voice (e.g., audio) to text (e.g., lighting) information. The conversion may start when user sets Sensory User Settings and, for example, creates a user filter (for example, denial to receive audio), but wants to retain all useful parts of information.

There are different forms of information. For example, audio information may include Morse coding, Speech, Natural sounds (laughing, screaming, singing, sounds of the weather like rain or wind), Unnatural sound (car noise, machinery noise, siren, etc.). Light may include Pictures, Symbols (text, hieroglyphs, musical annotations, other), Morse (dot-dash using light, using symbolic interpretation), and Color information. Other types of information may include Smell, Taste, Perception, Touch, and Temperature information. All of these types of information may be collected from users at a UE and/or converted at server 605.

For example, Symbol↔Speech conversion may include Audio to text conversion, including expressing emotions and emotional tone in text using color, size of text, and special musical annotations (Legato, Staccato, etc). Text to audio conversion uses special SSML annotation to bring tone to synthesized voice. Natural sounds↔symbol conversion may include expressing sound of rain in text. Unnatural sound↔symbol conversion may include a smart recognizer— that is, when the siren is heard it means that there is an emergency situation, so the message may say: “A siren alerts to be careful of an emergency situation”.

Different decoding techniques may enable direct communication between machine and human, without a machine recognizing a human voice directly. Picture↔Speech conversion may include a smart describer. For example, it may describe a painting of Da-Vinci by stating “Here is women wearing a long dress, with baby in her hands”. A Color↔Speech conversion may be according to developed palette, “red” is “scare”, “pink” is “love”, “black” is “sadness”, “orange” is “happiness”. (so the message will be “I am scared” or “I am happy”, or “I am in love”).

A Color↔Natural sound conversion may include things like “yellow” is “laughing”, “red” is “screaming”, etc. A Color↔Unnatural sound conversion may include connections such as “red” is “alarm”, “green” is “positive notification”, etc. Other conversion possibilities may include Color↔Smell, Speech↔Perception, Smell↔Speech, Taste↔Perception, and so on.

Chatterbot component 695 may generate a chatterbot message based at least in part on an automatic message generation algorithm. Chatterbots may be computer programs which conduct a conversation via auditory or textual methods. Chatterbots may be designed to convincingly simulate how a human would behave as a conversational partner. In some cases, content generated by chatterbot component 695 may be combined with human generated messages.

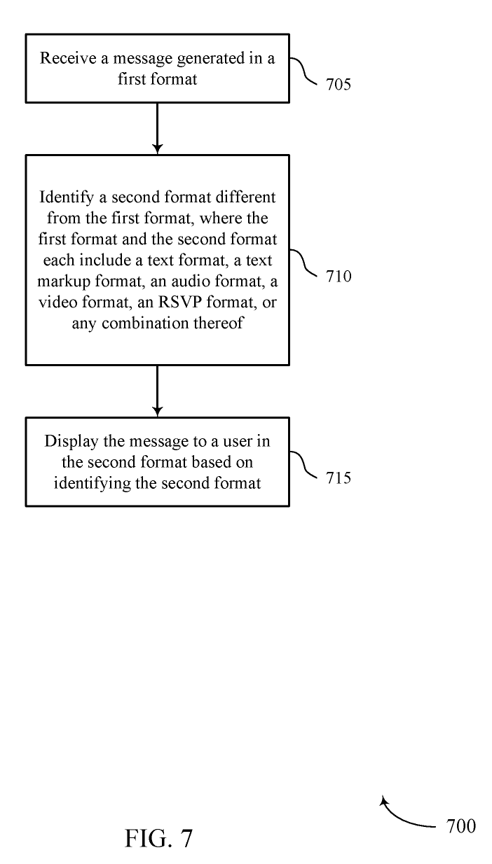

FIG. 7 shows a flowchart 700 of a process for multipurpose and multiformat instant messaging in accordance with aspects of the present disclosure. In some examples, a flowchart may execute a set of codes to control functional elements of the flowchart to perform the described functions. Additionally or alternatively, a flowchart may use special-purpose hardware.

At block 705 the flowchart may receive a message generated in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 710 the flowchart may identify a second format different from the first format, wherein the first format and the second format each comprise a text format, a text markup format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format component 225 as described with reference to FIG. 2.

At block 715 the flowchart may display the message to a user in the second format based on identifying the second format. These operations may be performed according to the methods and processes described in accordance with aspects of the present disclosure. For example, the operations may be composed of various substeps, or may be performed in conjunction with other operations described herein. In certain examples, aspects of the described operations may be performed by display component 230 as described with reference to FIG. 2.

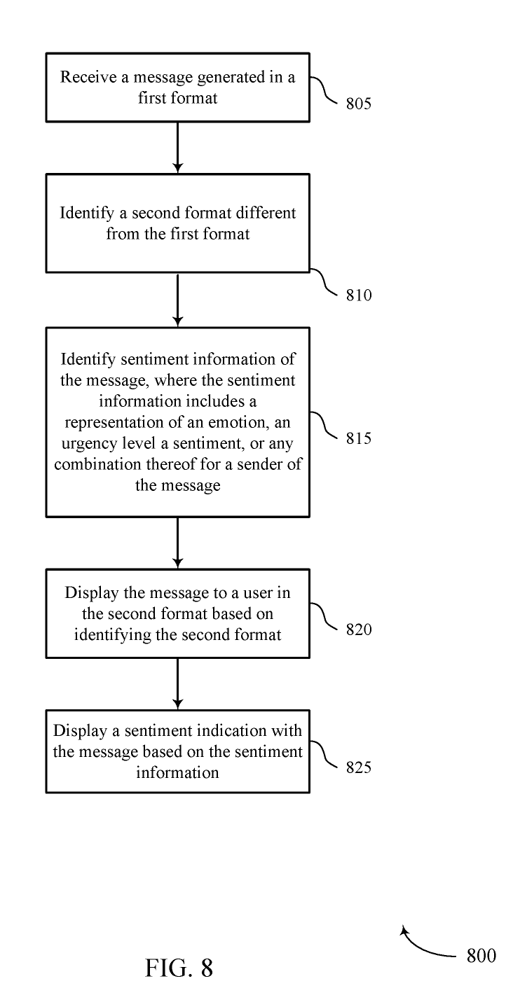

FIG. 8 shows a flowchart 800 of a process for multipurpose and multiformat instant messaging with sentiment settings in accordance with aspects of the present disclosure. In some examples, a flowchart may execute a set of codes to control functional elements of the flowchart to perform the described functions. Additionally or alternatively, a flowchart may use special-purpose hardware.

At block 805 the flowchart may receive a message generated in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 810 the flowchart may identify a second format different from the first format, wherein the first format and the second format each comprise a text format, a text markup format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format component 225 as described with reference to FIG. 2.

At block 815 the flowchart may identify sentiment information of the message, wherein the sentiment information comprises a representation of an emotion, an urgency level a sentiment, or any combination thereof a sender of the message. These operations may be performed according to the methods and processes described in accordance with aspects of the present disclosure. For example, the operations may be composed of various substeps, or may be performed in conjunction with other operations described herein. In certain examples, aspects of the described operations may be performed by sentiment component 235 as described with reference to FIG. 2.

At block 820 the flowchart may display the message to a user in the second format based on identifying the second format. These operations may be performed according to the methods and processes described in accordance with aspects of the present disclosure. For example, the operations may be composed of various substeps, or may be performed in conjunction with other operations described herein. In certain examples, aspects of the described operations may be performed by display component 230 as described with reference to FIG. 2.

At block 825 the flowchart may display a sentiment indication with the message based on the sentiment information. These operations may be performed according to the methods and processes described in accordance with aspects of the present disclosure. For example, the operations may be composed of various substeps, or may be performed in conjunction with other operations described herein. In certain examples, aspects of the described operations may be performed by display component 230 as described with reference to FIG. 2.

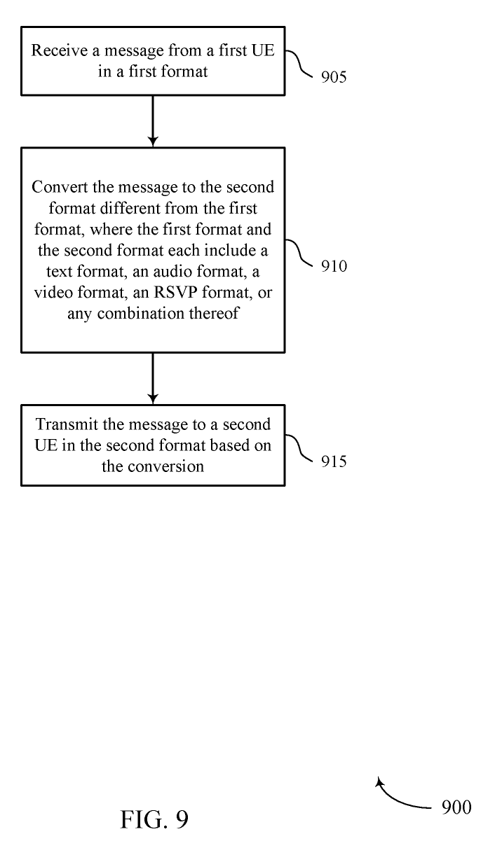

FIG. 9 shows a flowchart 900 of a process for format conversion for multipurpose and multiformat instant messaging in accordance with aspects of the present disclosure. In some examples, a flowchart may execute a set of codes to control functional elements of the flowchart to perform the described functions. Additionally or alternatively, a flowchart may use special-purpose hardware.

At block 905 the flowchart may receive a message from a first UE in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 910 the flowchart may convert the message to the second format different from the first format, wherein the, first format and the second format each comprise a text format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format conversion component 625 as described with reference to FIG. 6.

At block 915 the flowchart may transmit the message to a second UE in the second format based on the conversion. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

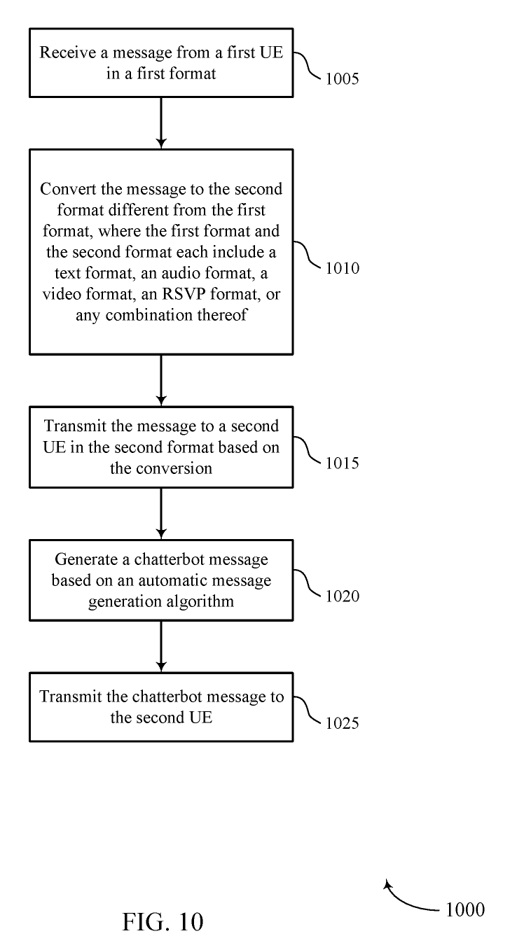

FIG. 10 shows a flowchart 1000 of a process for format conversion with a chatterbot for multipurpose and multiformat instant messaging in accordance with aspects of the present disclosure. In some examples, a flowchart may execute a set of codes to control functional elements of the flowchart to perform the described functions. Additionally or alternatively, a flowchart may use special-purpose hardware.

At block 1005 the flowchart may receive a message from a first UE in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 1010 the flowchart may convert the message to the second format different from the first format, wherein the first format and the second format each comprise a text format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format conversion component 625 as described with reference to FIG. 6.

At block 1015 the flowchart may transmit the message to a second UE in the second format based on the conversion. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

At block 1020 the flowchart may generate a chatterbot message based at least in part on an automatic message generation algorithm. These operations may be performed according to the methods and processes described in accordance with aspects of the present disclosure. For example, the operations may be composed of various substeps, or may be performed in conjunction with other operations described herein. In certain examples, aspects of the described operations may be performed by chatterbot component 686 as described with reference to FIG. 6.

At block 1025 the flowchart may transmit the chatterbot message to the second UE. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

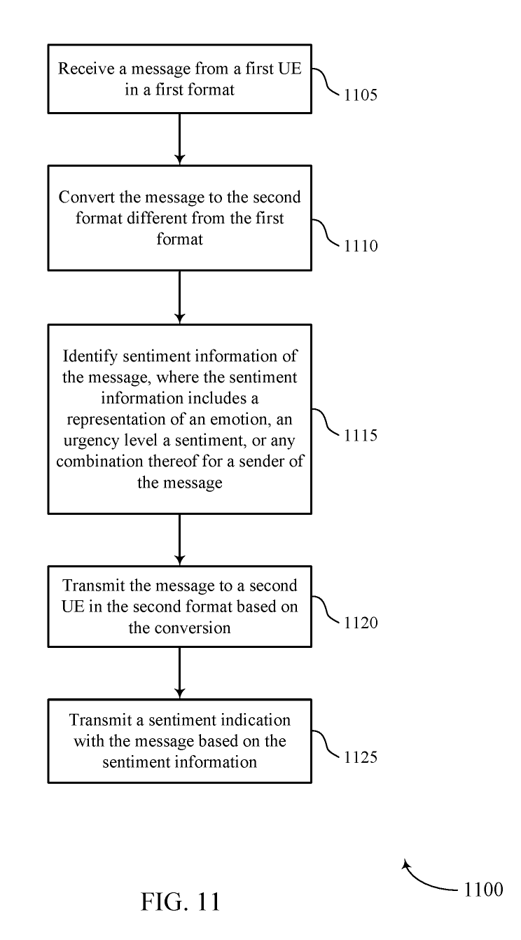

FIG. 11 shows a flowchart 1100 of a process for format conversion with sentiment settings for multipurpose and multiformat instant messaging in accordance with aspects of the present disclosure. In some examples, a flowchart may execute a set of codes to control functional elements of the flowchart to perform the described functions. Additionally or alternatively, a flowchart may use special-purpose hardware.

At block 1105 the flowchart may receive a message from a first UE in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 1110 the flowchart may convert the message to the second format different from the first format, wherein the first format and the second format each comprise a text format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format conversion component 625 as described with reference to FIG. 6.

At block 1115 the flowchart may identify sentiment information of the message, wherein the sentiment information comprises a representation of an emotion, an urgency level a sentiment, or any combination thereof a sender of the message. These operations may be performed according to the methods and processes described in accordance with aspects of the present disclosure. For example, the operations may be composed of various substeps, or may be performed in conjunction with other operations described herein. In certain examples, aspects of the described operations may be performed by sentiment identifier 660 as described with reference to FIG. 6.

At block 1120 the flowchart may transmit the message to a second UE in the second format based on the conversion. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

At block 1125 the flowchart may transmit a sentiment indication with the message based on the sentiment information. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

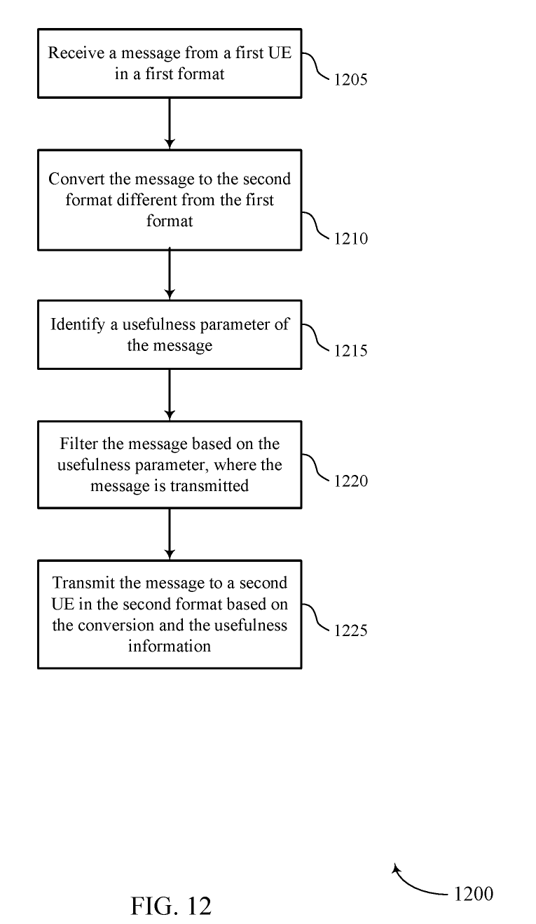

FIG. 12 shows a flowchart 1200 of a process for filtering based on usefulness information for multipurpose and multiformat instant messaging in accordance with aspects of the present disclosure. In some examples, a flowchart may execute a set of codes to control functional elements of the flowchart to perform the described functions. Additionally or alternatively, a flowchart may use special-purpose hardware.

At block 1205 the flowchart may receive a message from a first UE in a first format. These operations may be performed according to the methods and processes described in accordance with aspects of the present disclosure. For example, the operations may be composed of various substeps, or may be performed in conjunction with other operations described herein. In certain examples, aspects of the described operations may be performed by receiver 210 and 610 as described with reference to FIGS. 2 and 6.

At block 1210 the flowchart may convert the message to the second format different from the first format, wherein the first format and the second format each comprise a text format, an audio format, a video format, an RSVP format, or any combination thereof. These operations may be performed according to the methods and processes described in accordance with aspects of the present disclosure. For example, the operations may be composed of various substeps, or may be performed in conjunction with other operations described herein. In certain examples, aspects of the described operations may be performed by format conversion component 625 as described with reference to FIG. 6.

At block 1215 the flowchart may identify a usefulness parameter of the message. These operations may be performed according to the methods and processes described in accordance with aspects of the present disclosure. For example, the operations may be composed of various substeps, or may be performed in conjunction with other operations described herein. In certain examples, aspects of the described operations may be performed by usefulness identifier 682 as described with reference to FIG. 6.

At block 1220 the flowchart may filter the message based on the usefulness parameter, wherein the message is transmitted. These operations may be performed according to the methods and processes described in accordance with aspects of the present disclosure. For example, the operations may be composed of various substeps, or may be performed in conjunction with other operations described herein. In certain examples, aspects of the described operations may be performed by filter component 684 as described with reference to FIG. 6.

At block 1225 the flowchart may transmit the message to a second UE in the second format based on the conversion and the usefulness information. These operations may be performed according to the methods and processes described in accordance with aspects of the present disclosure. For example, the operations may be composed of various substeps, or may be performed in conjunction with other operations described herein. In certain examples, aspects of the described operations may be performed by transmitter 215 and 615 as described with reference to FIGS. 2 and 6.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a DSP, an ASIC, an FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for instant messaging, comprising:
receiving a message generated in a first format;
identifying a second format different from the first format, wherein the first format and the second format each comprise a text format, a text markup format, an audio format, a video format, a rapid serial visual presentation (RSVP) format, or any combination thereof; and
displaying the message to a user in the second format based on identifying the second format.

2. The method of claim 1, further comprising:
identifying sentiment information of the message, wherein the sentiment information comprises a representation of an emotion, an urgency level a sentiment, or any combination thereof a sender of the message; and
displaying a sentiment indication with the message based on the sentiment information.

3. The method of claim 2, wherein:
the sentiment indication comprises a color, a sound, an image, an icon, a smell, a tactile response, or any combination thereof.

4. The method of claim 1, further comprising:
identifying a location of the sender of the message; and
displaying an indication of the location with the message.

5. The method of claim 1, further comprising:
identifying weather information associated with the message; and
displaying the weather information with the message.

6. The method of claim 1, further comprising:
identifying a usefulness parameter of the message, wherein the message is displayed based at least in part on the usefulness information.

7. A method for instant messaging, comprising:
receiving a message from a first user equipment (UE) in a first format;
converting the message to the second format different from the first format, wherein the first format and the second format each comprise a text format, an audio format, a video format, an RSVP format, or any combination thereof; and
transmitting the message to a second UE in the second format based on the conversion.

8. The method of claim 7, further comprising:
generating a chatterbot message based at least in part on an automatic message generation algorithm; and
transmitting the chatterbot message to the second UE.

9. The method of claim 7, further comprising:
identifying sentiment information of the message, wherein the sentiment information comprises a representation of an emotion, an urgency level a sentiment, or any combination thereof a sender of the message; and
transmitting a sentiment indication with the message based on the sentiment information.

10. The method of claim 9, wherein:
the sentiment information comprises a sentiment mode setting of the first UE, the second UE, or both.

11. The method of claim 9, wherein:
the sentiment information is based on the content of the message.

12. The method of claim 11, further comprising:
processing the content of the message using a computer learning algorithm, wherein the sentiment information is based on processing the content of the message.

13. The method of claim 7, further comprising:
identifying a usefulness parameter of the message; and
filtering the message based on the usefulness parameter, wherein the message is transmitted based at least in part on the usefulness information.

14. The method of claim 13, further comprising:
identifying a filter setting of the second UE, wherein filtering the message is based on the filter setting.

15. An apparatus for instant messaging, comprising:
a processor; and
a memory storing instructions and in electronic communication with the processor, the processor being configured to execute the instructions to:
receive a message generated in a first format;
identify a second format different from the first format, wherein the first format and the second format each comprise a text format, a text markup format, an audio format, a video format, an RSVP format, or any combination thereof; and
display the message to a user in the second format based on identifying the second format.

16. The apparatus of claim 15, wherein processor is further configured to execute the instructions to:
identify sentiment information of the message, wherein the sentiment information comprises a representation of an emotion, an urgency level a sentiment, or any combination thereof a sender of the message; and
display a sentiment indication with the message based on the sentiment information.

17. The apparatus of claim 16, wherein:
the sentiment indication comprises a color, a sound, an image, an icon, a smell, a tactile response, or any combination thereof.

18. The apparatus of claim 15, wherein processor is further configured to execute the instructions to:
identify a location of the sender of the message; and
display an indication of the location with the message.

19. The apparatus of claim 15, wherein processor is further configured to execute the instructions to:
identify weather information associated with the message; and
display the weather information with the message.

20. The apparatus of claim 15, wherein processor is further configured to execute the instructions to:
identify a usefulness parameter of the message, wherein the message is displayed based at least in part on the usefulness information.
